(19) United States
(12) Patent Application Publication
(10) Pub. No.: US 2009/0061794 A1
(43) Pub. Date: Mar. 5, 2009

(54) HINGE ASSEMBLIES FOR ELECTRONIC DEVICES

(75) Inventors: Brian J. HASSEMER, Gurnee, IL (US); Roger W. Harmon, Crystal Lake, IL (US); Jonathan M. Hewitt, Reading (GB); Nicholas A. Jinkinson, Reading (GB)

Correspondence Address: PRASS LLP, 2661 Riva Road, Bldg. 1000, Suite 1044, ANNAPOLIS, MD, 21401, US

(73) Assignee: Motorola, Inc., Schaumburg, IL (US)

(21) Appl. No.: 11/846,216

(22) Filed: Aug. 28, 2007

(51) Int. Cl. H04B 1/38; E05D 1/00

(52) U.S. Cl. 455/90.3; 16/225; 16/227

(57) ABSTRACT

A handheld communication device may comprise a first housing including a first keypad, a main printed circuit board, and a battery. A second housing may include at least one display, and the first and second housings may be rotatable relative to one another. The device may comprise a hinge barrel containing a biasing member and at least one cam follower. The hinge barrel may be rotatable relative to the first and second housings.

### TECHNICAL FIELD

The present invention is directed to electronic devices such as, for example, handheld communication devices. More particularly, the present invention is directed to hinge assemblies for handheld communication devices such as, for example, cellular telephones, which have at least a two-part housing, where a first housing member is adapted to rotate relative to a second housing member.

### BACKGROUND

There is an interest in making certain handheld electronic devices, such as cellular telephones, with a seamless design look. Making such devices with a seamless design look makes them more visually attractive to users and more likely that users will accessorize their wardrobe with such attractive devices.

Some conventional handheld electronic devices have hinges that are as thick as the device itself. That is, the hinge extends across the entire width and the depth at one end of the electronic device. Conventional hinges often include one a pair of end leaves extending from a first housing of the device and a center leave extending from a second housing of the device.

Such conventional hinges do not present a seamless design. For example, when the electronic device is closed and viewed from an exterior of the device, the hinge presents a broken-up look, with the interfaces between various components of the hinge plainly visible. Similarly, when the electronic device is opened, such conventional hinges protrude prominently from the first and second housings, with the interfaces between the various hinge components being plainly visible.

It may be desirable to provide a handheld electronic device with a hinge assembly that presents a relatively seamless design look when the device is opened and closed. Such a seamless design look may be more desirable to users that consider their handheld device to be a fashion accessory.

### SUMMARY OF THE INVENTION

According to various aspects of the disclosure, a handheld communication device may comprise a first housing including a first keypad, a main printed circuit board, and a battery. A second housing may include at least one display, and the first and second housings may be rotatable relative to one another. The device may comprise a hinge barrel containing a biasing member and at least one cam follower. The hinge barrel may be rotatable relative to the first and second housings.

In accordance with some aspects of the disclosure, a handheld communication device may comprise a first housing including a first keypad, a main printed circuit board, and a battery, and a second housing including at least one display. The first and second housings may be rotatably coupled to one another and movable between a closed configuration and an open configuration. The device may comprise a hinge barrel rotatably coupled to the first and second housings. The hinge barrel may be visible from an exterior of the device in the closed configuration.

In some aspects of the disclosure, a handheld communication device may comprise a first housing including a first keypad, a main printed circuit board, and a battery; a second housing including at least one display; and a hinge assembly. The first and second housings being rotatably coupled to one another via the hinge assembly. The hinge assembly may comprise a hinge barrel, at least one leave extending from the first housing, and at least one leave extending from the second housing. The hinge barrel may include a pair of opposed end leaves and at least one interior leave between the end leaves.

### BRIEF DESCRIPTION OF THE DRAWINGS

In order to describe the manner in which the above-recited and other features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a side view of an exemplary handheld communication device in a first configuration, for example, a closed position, in accordance with various aspects of the disclosure;

FIG. 2 is a perspective view of the first handheld communication device of FIG. 1 in a second configuration, for example an opened position;

FIG. 3 is an exploded view of a portion of an exemplary hinge assembly of the handheld communication device shown in FIGS. 1-2;

FIG. 4 is a perspective view of the portion of the exemplary hinge assembly shown in FIG. 3;

FIG. 5 is a rear perspective view of an exemplary flip inner housing part of the communication device of FIGS. 1 and 2 in accordance with various aspects of the disclosure;

FIG. 6 is a rear perspective view of an exemplary base inner housing part of the communication device of FIGS. 1 and 2 in accordance with various aspects of the disclosure;

FIG. 7 is a block diagram of the handheld communication device shown in FIGS. 1-6.

### DETAILED DESCRIPTION

Additional features and advantages of the invention will be set forth in the description which follows, and in part will be obvious from the description, or may be learned by practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth herein.

Various embodiments of the invention are discussed in detail below. While specific implementations are discussed, it should be understood that this is done for illustration purposes only. A person skilled in the relevant art will recognize that other components and configurations may be used.

The present disclosure comprises a variety of embodiments, such as methods and apparatus and other embodiments that relate to the basic concepts of the invention.

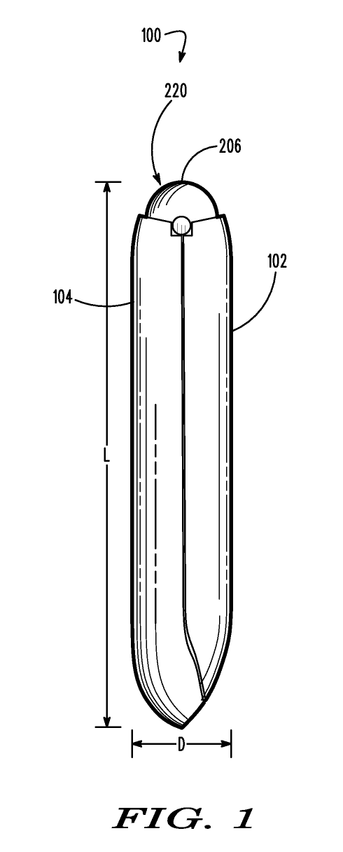

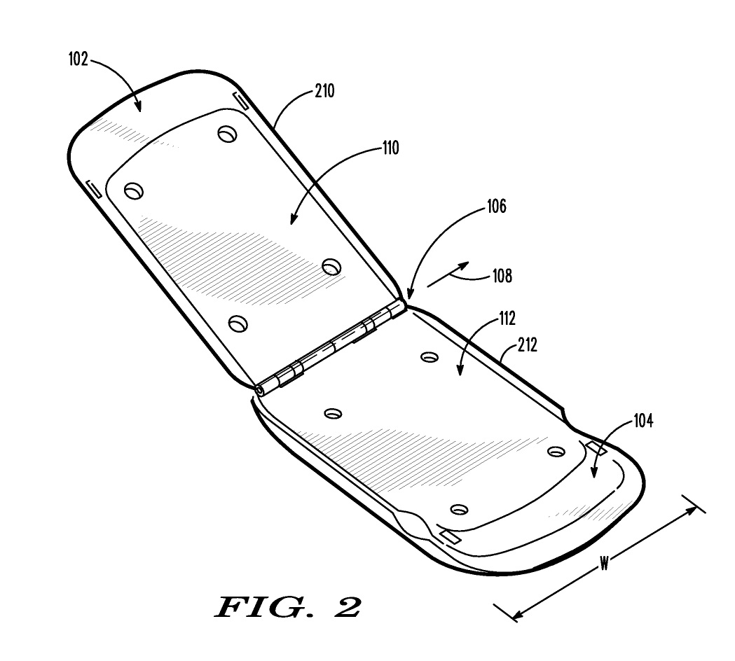

FIG. 1 is a side view of an exemplary handheld communication device having at least a two-part housing, for example, a clamshell wireless communication device 100, shown in a first configuration, for example, a closed configuration, and FIG. 2 is a second perspective view of the handheld communication device 100, shown in a second configuration, for example, an open configuration.

The device 100 may comprise an upper housing 102, which may be referred to as a flip, and a lower housing 104, which may be referred to as a base. In some aspects, a first housing may comprise the upper housing 102, and a second housing may comprise the lower housing 104. In other aspects, the first housing may comprise the lower housing 104, and the second housing may comprise the upper housing 102.

The flip 102 and the base 104 may be coupled by a rotational coupling such as, for example, a hinge assembly 106 such that the flip 102 and base 104 are movable relative to one another. The hinge assembly 106 may include a hinge barrel 206 movable relative to the flip 102 and the base 104. As shown in FIG. 1, the flip 102, the base 104, and the hinge barrel 206 may be all that is visible when the device 100 is in the closed configuration.

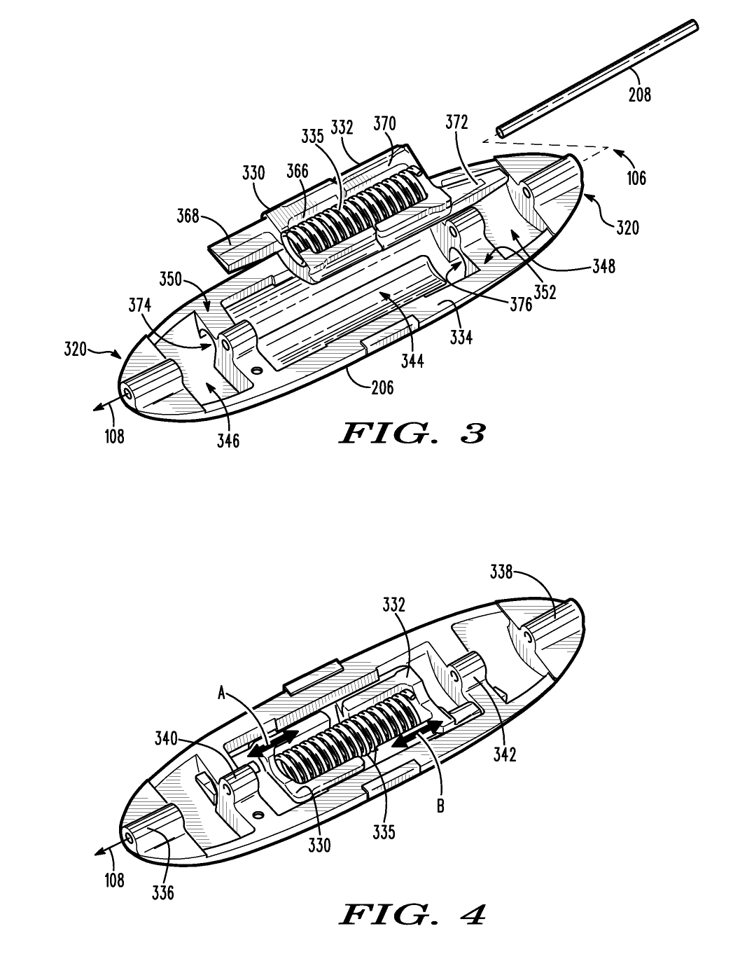

As shown in FIG. 2, according to some aspects, the hinge assembly 106 may comprise a piano-type hinge. An axis 108 of the hinge assembly 106 may be substantially aligned with the width dimension W of the device 100. The hinge assembly 106 may allow the flip 102 to be rotated from the first configuration in which the flip 102 overlies the base 104, i.e., a closed position, to the second configuration in which the flip 102 extends upward away from the base 104, i.e., an opened position. An exemplary structure of the hinge assembly 106 is discussed in more detail below in reference to FIGS. 3-7.

The device 100 may be relatively flat, which is to say that its depth D dimension may be significantly less than its width W and length L dimensions. In some aspects, a reduced depth may be an overall design goal. The flip 102 may comprise a flip inner housing member 110 and a flip outer housing member 210, which may be coupled together, for example, by screws (not shown), or coupled together using one or more other well known elements and/or methods.

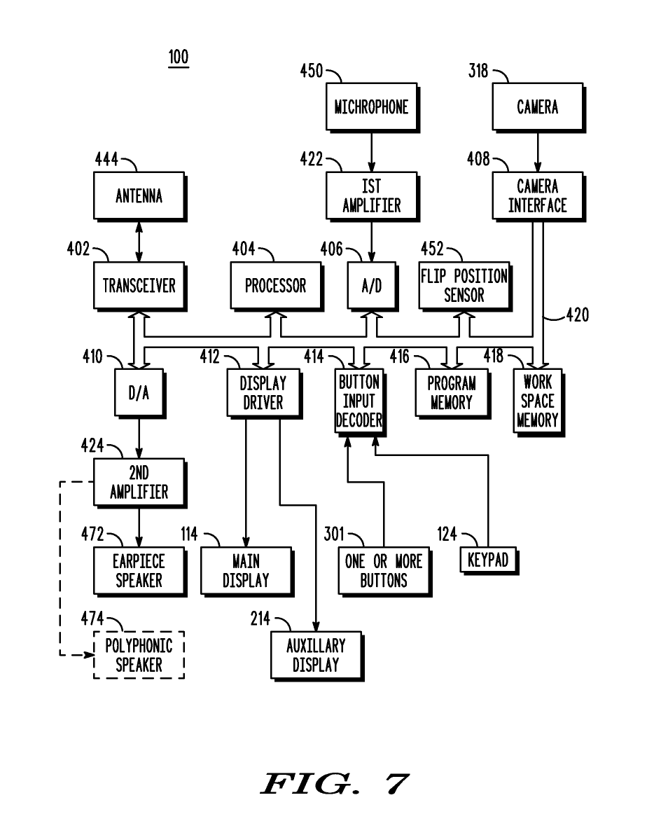

According to some aspects, a main display 114 (FIG. 7; not shown in FIGS. 1-6) of the device 100 may be located at the flip inner housing member 110, and an auxiliary display 214 (FIG. 7; not shown in FIGS. 1-6) may be located at the flip outer housing member 210. The main display and the auxiliary display may be useful for displaying control screens including menus and information related to communications including lists of received calls, lists of placed calls, telephone numbers in a phone book, email addresses and web addresses, as well as a list of selectable functions, among other things.

A number of components may be located in the flip 102 between the flip outer housing member 210 and the flip inner housing member 110. These components may include a display module that includes the main display and the auxiliary display, an earpiece speaker, and/or a flexible circuit. A camera may be incorporated as part of the device 100 in the space occupied by the hinge 106. The flip inner housing member 110 may include an integrally molded rectangular frame is sized to receive at least a portion of the display module.

In various aspects, the flip 102 may comprise one or more buttons 301 (FIG. 7; not shown in FIGS. 1-6) on side edges of the flip 102 and/or the base 104. The button(s) may be used to generate signals for controlling various aspects of the operation of the device 100. For example, in one or more modes of operation of the device 100, a pair of buttons may be used as directional inputs, such as “UP” and “DOWN” commands, to control software of the device 100.

The base 104 may comprise a base inner housing member 112, and a base outer housing member 212, which may be coupled together, for example, by screws (not shown), or coupled together using one or more other well known elements and/or methods. A keypad 124 (FIG. 7; not shown in FIGS. 1-6) may be located on the inside surface 112 of the base 104.

A number of components may be located in the base 104 between the base outer housing member 212 and the base inner housing member 210. For example, a battery compartment may be defined between the base inner housing member 112, a battery compartment cover may be located adjacent the base outer housing member 212, and a battery may be substantially disposed in the battery compartment. The base 104 may contain an antenna, a populated printed circuit board that includes communication and control circuits of the device 100, and a transducer, which may be adapted to provide vibrational feedback to the user.

A portion of the base inner housing member 210 may include a Hall effect sensor configured to work in conjunction with a magnet in the flip inner housing part 110 to sense whether the flip 102 is positioned overlying the base 104, such as a proximately closed position, as shown in FIG. 1, or extended away from the base 104, such as in an opened position, as shown in FIG. 2. A flexible circuit feedthrough connects circuits in the base 104 to circuits in the flip 102. In the assembled device 100, the flexible circuit feedthrough passes through the hinge barrel 206.

Referring now to FIGS. 3-6, the hinge assembly 106 may comprise the hinge barrel 206, the flip and base inner housing members 110, 210, a pair of cam followers 330, 332, and a biasing member 335. The biasing member 335 may comprise, for example, a coil spring. The hinge barrel 206 and the flip and base inner housing members 110, 210 may be coupled together with a hinge pin 208 (FIG. 2)

The hinge barrel 206 may be substantially semi-cylindrical with a substantially rounded exterior surface 220, as shown in FIG. 1. As shown in FIGS. 3 and 4, a side 334 of the hinge barrel 206 opposite the rounded surface 220 may comprise one or more cavities and one or more protrusions.

According to various aspects of the disclosure, the hinge barrel 206 includes a pair of opposed end leaves 336, 338 and a pair of interior leaves 340, 342 extending from the side 334. The side 334 includes a middle cavity 344 and a pair of outside cavities 346, 348. The first outside cavity 346 is separated from the middle cavity 344 by a first wall 350, and the second outside cavity 348 is separated from the middle cavity 344 by a second wall 352.

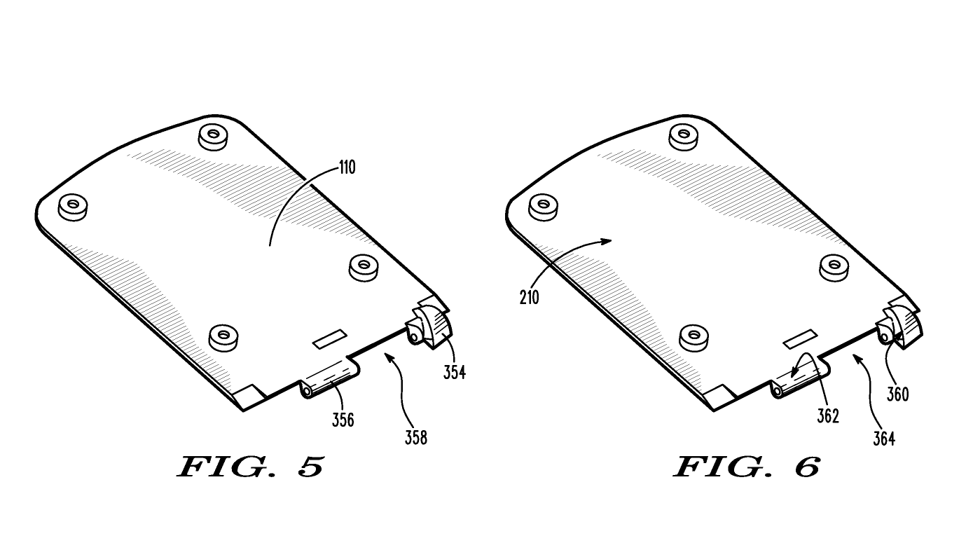

The flip inner housing part 110 may comprise a first cam 354 and a first leave 356 extending from a first end 358 thereof (FIG. 5). The first outside cavity 346 of the hinge barrel 206 may be sized and arranged to receive the first cam 354. Similarly, the base inner housing part 210 may comprise a second cam 360 and a second leave 362 extending from a first end 364 thereof (FIG. 6). The second outside cavity 348 of the hinge barrel 206 may be sized and arranged to receive the second cam 360. The first and second cams 354, 360 may be rotatable about the hinge axis 108 relative to the hinge barrel.

The first cam follower 330 may comprise a sleeve portion 366 configured to receive the spring 335 and an extension 368 configured to be operably coupled with the first cam 354. Similarly, the second cam follower 332 may comprise a sleeve portion 370 configured to receive the spring 335 and an extension 372 configured to be operably coupled with the second cam 360.

The middle cavity 344 may be sized and arranged to house the spring 335 and the sleeve portions 366, 370 of the cam followers 330, 332. The spring 335 may be sandwiched between the sleeve portions 366, 370. The first and second walls 350, 352 may each include an opening 374, 376 therethrough configured to receive the extensions 368, 372, respectively. The openings 374, 376 and extensions 368, 372 may be sized such that the extensions 368, 372 may be slidable relative to the openings 374, 376 in directions A, B substantially aligned with the axis 108 of the hinge assembly 106.

The spring 335 may be configured to urge the cam followers 330, 332 away from one another. For example, the first cam follower 330 may be urged toward the first wall 350, and the second cam follower 332 may be urged toward the second wall 352. The first and second walls 350, 352 may act as stops for limiting the axial movement of the followers 330, 332.

The first cam follower 330 may be operably coupled with the first cam 354 such that rotation of the first cam 354 may cause the extension 368 of the first cam follower 330 to ride along the curved surface of the first cam 354. The curved surface of the first cam 354 may urge the first cam follower 330 in a direction toward the spring 335 and the second cam follower 332.

Similarly, the second cam follower 332 may be operably coupled with the second cam 360 such that rotation of the second cam 360 may cause the extension 370 of the second cam follower 332 to ride along the curved surface of the second cam 360. The curved surface of the second cam 360 may urge the second cam follower 332 in a direction toward the spring 335 and the first cam follower 330.

As shown in FIGS. 5 and 6, the cams 354, 360 may include a single contour such that the spring 335 may be axially compressed when the device 100 is in the closed configuration of FIG. 1 and uncompressed when the device 100 is in the open configuration of FIG. 2. It should be appreciated that the cams 354, 360 may have any other known cam contour, such as, for example, a contour similar to that disclosed in U.S. Pat. No. 6,065,187 to Mischenko, which is incorporated herein by reference.

The hinge assembly 106 may be assembled by sandwiching the spring 335 between the first and second cam followers 330, 332 in the sleeves 366, 370 thereof. The first and second cam followers 330, 332 may then be placed in the middle cavity 344 with the extensions 368, 372 extending through openings 374, 376 in the first and second wall 350, 352, respectively. One of the cams, for example, the second cam 360 associated with the base inner housing part 210, may be placed in the second outside cavity 348 and into operable communication with the second cam follower 332. The other of the cams, for example, the first cam 354 associated with the flip inner housing part 110 may be placed in the first outside cavity 346 and into operable communication with the first cam follower 330. The hinge pin 208 may be inserted through one of the end leaves 336, 338, through an adjacent bore in the first or second cam 354, 360, through one of the interior leaves 340, 342 of the hinge barrel 206, through the leaves 356, 362 of the flip and base inner housing parts 110, 210, through the other of the interior leaves 340, 342 of the hinge barrel 206, through an adjacent bore in the other cam 354, 360, and through the other of the end leaves 336, 338. It should be appreciated that, in some aspects, the first cam 354 may be assembled before the second cam 360.

Since the spring 335 is axially compressed when the device 100 is in the closed configuration of FIG. 1, the device 100 may include one or more pairs of magnets 280 (FIG. 2) for assisting in maintaining the device 100 in the closed configuration. Such magnets and use are well known by those skilled in the art.

FIG. 7 is an exemplary block diagram of the handheld communication device 100 shown in FIGS. 1-6. As shown in FIG. 7 the device 100 may comprise a transceiver 402, a processor 404, an analog-to-digital converter (A/D) 406, a flip position sensor 452, a camera interface 408, a digital-to-analog converter (D/A) 410, a display driver 412, a button interface decoder 414, a program memory 416, and/or a workspace memory 418 coupled together through a system bus 420.

The transceiver 402 may be coupled to an antenna 444. Radio Frequency and/or microwave signals that are modulated with encoded data (e.g., digitized voice audio, text messages, photos, etc.) may pass between the transceiver 402 and the antenna 444.

The processor 404 executes control programs, and may also perform communication encoding and decoding tasks. Programs executed by the processor 404 may be stored in the program memory 416. The processor 404 may use the workspace memory 418 in executing programs. The processor 404 may be suitably part of a highly integrated micro-controller integrated circuit. The micro-controller suitably may include one or more of the other above-mentioned components that are coupled together through the signal bus 420. The transceiver 402, the processor 404, and optionally other blocks shown in FIG. 7 may be embodied in circuits of a populated printed circuit board (not shown).

A microphone 450 may be coupled through a first amplifier 422 to the A/D 406. The A/D 406 may be used to digitize a user's spoken words, which are then encoded by a voice encoder (vocoder) component of the processor.

A camera 318 may be interfaced to the processor 404 through the camera interface 408. The camera interface 408 may read and digitize pixel data from the camera 318, and make such data available to the processor 404 for further processing, e.g., image/video compression encoding.

The button input decoder 414 may be coupled to the one or more buttons 301 located in the flip 102 or the base 104, as well as to the keys of a keypad 124. The button input decoder 414 may receive the electrically encoded actuation signals from the keypad and the one or more buttons 460 and identify each depressed key or button to the processor 404.

The display driver 412 may drive the main display 114 and the auxiliary display 214. The D/A 410 may drive an earpiece speaker 472 through a second amplifier 424. A similar or the same circuit could also be used to drive a polyphonic speaker 474.

It is noted that, as used in this specification and the appended claims, the singular forms “a,” “an,” and “the,” include plural referents unless expressly and unequivocally limited to one referent. Thus, for example, reference to “a user input” includes two or more different user inputs. As used herein, the term “include” and its grammatical variants are intended to be non-limiting, such that recitation of items in a list is not to the exclusion of other like items that can be substituted or other items that can be added to the listed items.

It will be apparent to those skilled in the art that various modifications and variations can be made in the devices and methods of the present disclosure without departing from the scope of the invention. Other embodiments of the invention will be apparent to those skilled in the art from consideration of the specification and practice of the invention disclosed herein. It is intended that the specification and examples be considered as exemplary only.

What is claimed is:

1. A handheld communication device, comprising:
a first housing including a first keypad, a main printed circuit board, and a battery;
a second housing including at least one display, the first and second housings being rotatable relative to one another; and
a hinge barrel containing a biasing member and at least one cam follower, the hinge barrel being rotatable relative to the first and second housings.

2. The device of claim 1, further comprising a hinge assembly rotatably coupled to the first and second housings, the hinge assembly comprising
the hinge barrel, the hinge barrel including a pair of opposed end leaves and at least one interior leave between the end leaves,
at least one leave extending from the first housing, and
at least one leave extending from the second housing.

3. The device of claim 2, wherein the pair of opposed end leaves, the at least one interior leave, the at least one leave of the first housing, and the at least one leave of the second housing are arranged in a piano hinge configuration.

4. The device of claim 2, wherein the first and second housings are movable between a closed configuration and an open configuration, the hinge barrel being visible from an exterior of the device in the closed configuration.

5. The device of claim 1, wherein the at least one cam follower comprises a first cam follower and a second cam follower, the biasing member being sandwiched between the first and second cam followers and configured to urge the first and second cam followers in opposite directions.

6. The device of claim 1, further comprising
a first cam extending from the first housing, the first cam being operably coupled with the first cam follower; and
a second cam extending from the second housing, the second cam being operably coupled with the second cam follower.

7. The device of claim 6, further comprising a hinge assembly rotatably coupled to the first and second housings, the hinge assembly comprising
the hinge barrel, the hinge barrel including a pair of opposed end leaves and at least one interior leave between the end leaves;
at least one leave extending from the first housing;
at least one leave extending from the second housing; and
the first and second cams.

8. A handheld communication device, comprising:
a first housing including a first keypad, a main printed circuit board, and a battery;
a second housing including at least one display, the first and second housings being rotatably coupled to one another and movable between a closed configuration and an open configuration; and
a hinge barrel rotatably coupled to the first and second housings, the hinge barrel being visible from an exterior of the device in the closed configuration.

9. The device of claim 8, further comprising a hinge assembly, the hinge assembly comprising:
the hinge barrel, the hinge barrel including a pair of opposed end leaves and at least one interior leave between the end leaves;
at least one leave extending from the first housing; and
at least one leave extending from the second housing.

10. The device of claim 9, wherein the pair of opposed end leaves, the at least one interior leave, the at least one leave of the first housing, and the at least one leave of the second housing are arranged in a piano hinge configuration.

11. The device of claim 8, wherein the hinge barrel contains a biasing member, a first cam follower, and a second cam follower, the biasing member being sandwiched between the first and second cam followers and configured to urge the first and second cam followers in opposite directions.

12. The device of claim 11, further comprising
a first cam extending from the first housing, the first cam being operably coupled with the first cam follower; and
a second cam extending from the second housing, the second cam being operably coupled with the second cam follower.

13. The device of claim 12, further comprising a hinge assembly rotatably coupled to the first and second housings, the hinge assembly comprising:
the hinge barrel, the hinge barrel including a pair of opposed end leaves and at least one interior leave between the end leaves;
at least one leave extending from the first housing;
at least one leave extending from the second housing; and
the first and second cams.

14. A handheld communication device, comprising:
a first housing including a first keypad, a main printed circuit board, and a battery;
a second housing including at least one display; and
a hinge assembly, the first and second housings being rotatably coupled to one another via the hinge assembly, the hinge assembly comprising
a hinge barrel, the hinge barrel including a pair of opposed end leaves and at least one interior leave between the end leaves,
at least one leave extending from the first housing, and
at least one leave extending from the second housing.

15. The device of claim 14, wherein the pair of opposed end leaves, the at least one interior leave, the at least one leave of the first housing, and the at least one leave of the second housing are arranged in a piano hinge configuration.

16. The device of claim 14, wherein the first and second housings are movable between a closed configuration and an open configuration, the hinge barrel being visible from an exterior of the device in the closed configuration.

17. The device of claim 14, wherein the hinge barrel contains a biasing member, a first cam follower, and a second cam follower, the biasing member being sandwiched between the first and second cam followers and configured to urge the first and second cam followers in opposite directions.

18. The device of claim 17, further comprising
a first cam extending from the first housing, the first cam being operably coupled with the first cam follower; and
a second cam extending from the second housing, the second cam being operably coupled with the second cam follower.

19. The device of claim 18, wherein the hinge assembly further comprises the first and second cams.
